(19) United States
(12) Patent Application Publication
(10) Pub. No.: US 2003/0034627 A1
(43) Pub. Date: Feb. 20, 2003

(54) Bi-directional pedaling system

(76) Inventors: Sang-Nyoun Kim, Seoul (KR); Soo-Yong Lee, Sungnam-si (KR)

Correspondence Address: EPSTEIN, EDELL, SHAPIRO, FINNAN & LYTLE, LLC, Suite 400, 1901 Research Boulevard, Rockville, MD, 20850, US

(21) Appl. No.: 10/135,928

(22) Filed: Apr. 30, 2002

(30) Foreign Application Priority Data
Aug. 14, 2001 (KR) 2001-49127

(51) Int. Cl. B62M 9/06

(52) U.S. Cl. 280/237; 280/260

(57) ABSTRACT

A forward drive apparatus for a bicycle is provided to work the bicycle in a forward rotation even during the back-pedaling of the bicycle.

The forward drive apparatus includes a forward drive unit fixed to a pedal shaft, and which transfers the forward rotating force of pedal arms to a drive sprocket wheel; and a reverse drive unit for rotating the driving sprocket wheel in a forward direction by a rotation direction converting unit fixed to the pedal shaft and which transfers the reverse rotating force of pedal arms into the forward rotating force.

The forward drive apparatus is advantageous in that the bicycle is driven forward through the simple reverse rotation of the pedal, without operating an additional clutch or lever, and the operation of bicycle is not interrupted at all even when the pedal has stopped during traveling. The bicycle is drawn in an easy manner in case where the user draws the bicycle rather than riding on it.

### FIELD OF THE INVENTION

The present invention relates to a forward drive apparatus for a bicycle, and more particularly, to a forward drive apparatus for a bicycle for working the bicycle in a forward rotation even during the back-pedaling of the bicycle.

### BACKGROUND OF THE INVENTION

In general, drive apparatus for a bicycle, for rotating bicycle pedal and moving the bicycle in a forward direction, includes a drive sprocket wheel fixed to a pedal shaft by the rotation of a pedal, a slave sprocket wheel for driving a rear wheel by the chain connected to the drive sprocket wheel, and a ratchet for transferring only the single direction rotating force of the slave sprocket wheel to a rear wheel axle.

Such a conventional drive apparatus for a bicycle is configured in that, when a pedal rotates in a reverse direction by the rider's back-pedaling, the slave sprocket wheel rotates in a reverse direction but the reverse rotating force of the slave sprocket wheel is not transferred to the rear wheel axle by the ratchet. As a consequence, the rear wheel axle rotates in a continuous manner, to thereby work the bicycle in a continuous forward movement. That is, when the pedal rotates in a reverse direction, the bicycle loses the propelling force since the slave sprocket wheel is idled.

However, because the forward drive apparatus forces the bicycle to be worked only in the forward movement during the normal pedaling, a bicycle rider easily gets feeling his leg's fatigue during the traveling of long-hour distance. Moreover, conventional forward drive apparatus is disadvantageous in that the bicycle provides exercising effects only when the pedal rotates in a single direction and cannot afford uniform exercising effects all over the muscle of rider's leg when the pedal rotates in a reverse direction which causes idling of the slave sprocket wheel.

To overcome such disadvantages, considerable effect has been focused on the driving apparatuses which work the bicycle in a forward movement even during a reverse rotation of the pedal.

Korean Patent Laid-open No. 1995-0029128 (dated Nov. 22, 1995) discloses a forward drive apparatus for a bicycle, including a forward driving unit for driving a bicycle in a forward movement during the forward rotation of a pedal; a reverse driving unit for converting the reverse rotation of the pedal into a forward rotation during the reverse rotation of the pedal; and a direction change unit constituted by a lever for coupling the reverse driving unit with the forward driving unit. However, this forward drive apparatus has drawbacks in that the rider has to operate the lever of the direction change unit when the rider intends to drive the bicycle in a forward direction through the reverse rotation of the pedal.

Korean Utility-Model Publication No. 1997-0054609 (dated Oct. 13, 1997) discloses a forward drive apparatus for a bicycle, including a first one-direction clutch arranged between a hub shaft and a slave sprocket wheel of the rear wheel such that the rotating force produced during the forward rotation of the slave sprocket wheel is transferred to the hub shaft; a relay gear arranged between the slave sprocket wheel and the protrusion of the hub shaft, and which converts the rotating force of the slave sprocket wheel into a rotating force of the opposite direction, and transferring the converted rotating force to the hub shaft; and a second one-direction clutch means arranged between a support bracket and an attachment shaft, and which allows the support bracket equipped with the shaft of the relay gear to idle in the same direction in its entirety during the forward rotation of the slave sprocket wheel, and allows the support bracket to be fixed at the attachment shaft during the reverse rotation of the slave sprocket wheel. However, the forward drive apparatus disclosed in Korean Utility-Model Publication No. 1997-0054609 has disadvantages in that the rotation of the pedal cannot be stopped during traveling. Furthermore, in case where the user intends to push the bicycle rather than riding on it, the pedal rotates in a reverse direction by the rotating force of the rear wheel, resulting in the increased consumption of force to move the bicycle. The user has to draw the bicycle, while maintaining a distance from the bicycle so as to avoid contacting the pedal rotating in a reverse direction. Moreover, it is impossible to stop the pedal during traveling.

In another prior art which is not described herein, the travel speed of the bicycle obtained by the reverse rotation of the pedal is further lower than the travel speed of the bicycle obtained by the forward rotation of the pedal.

### SUMMARY OF THE INVENTION

Therefore, it is an object of the present invention to provide a forward drive apparatus for a bicycle, capable of working the bicycle in a forward direction, similarly to the case where the pedal rotates in a forward direction, by the reverse rotation of the pedal without an additional lever operation.

A forward drive apparatus for a bicycle according to the present invention is advantageous in that the traveling of bicycle is not interfered at all even when the pedal has stopped during traveling, and the bicycle is drawn in an easy manner in case where the user draws the bicycle rather than riding on it.

A forward drive apparatus for a bicycle according to the present invention, includes a forward drive unit fixed to a pedal shaft, and which transfers the forward rotating force of pedal arms to a drive sprocket wheel; and a reverse drive unit for rotating the driving sprocket wheel in a forward direction by a rotation direction converting unit fixed to the pedal shaft and which transfers the reverse rotating force of pedal arms into the forward rotating force.

### DESCRIPTION OF THE DRAWINGS

FIG. 1 is a perspective view illustrating a forward drive apparatus according to a first embodiment of the present invention;

FIG. 2 is a cross section view illustrating the forward drive apparatus according to the first embodiment of the present invention;

FIG. 3 is a cross section view illustrating the operation state of a forward drive unit in accordance with the rotation direction of pedal shaft;

FIG. 4 is a cross section view illustrating the operation state of a reverse drive unit in accordance with the rotation direction of pedal shaft;

FIG. 5 is a cross section view illustrating a forward drive apparatus according to a second embodiment of the present invention;

FIG. 6 is a perspective view illustrating a reverse drive unit according to the second embodiment of the present invention;

FIG. 7 is a cross section view illustrating a forward drive unit according to a third embodiment of the present invention;

FIG. 8 is a perspective view illustrating a reverse drive unit according to a fourth embodiment of the present invention; and

FIG. 9 is a perspective view illustrating a reverse drive unit according to a fifth embodiment of the present invention.

### DETAILED DESCRIPTION OF THE PRESENT INVENTION

Now, the present invention will be explained in more detail with reference to the attached drawings.

A forward drive apparatus for a bicycle according to the present invention, includes a forward drive unit 100 in which a ratchet 11b is arranged at an outer periphery of a drive disk 11a fixed to a pedal shaft 5 through a key 8 such that only the forward rotating force of the pedal shaft is transferred to a drive sprocket wheel 4 by a ratchet wheel 12 fixed to a side surface of the drive sprocket wheel; and a reverse drive unit 200 including a rotation direction converting unit 230 for rotating a drive gear 34 having a center thereof supported to the pedal shaft through a bearing and which is formed integrally with a drive disk 21a, in the direction opposite to the rotating direction of the pedal shaft 5 by the rotating force of a fixing gear 31 connected to the pedal shaft, the drive disk 21a having at an outer periphery thereof a ratchet 21b and being formed integrally with the drive gear 34 of the rotation direction converting unit 230, and a ratchet wheel 22 fixed to the other side surface of the drive sprocket wheel 4 and interlocked with the ratchet 21b, wherein the reverse drive unit 200 does not transfer the rotation force to the drive sprocket wheel 4 during the forward rotation of the pedal shaft, but allow the drive disk to be rotated by the rotation force having a direction changed by the rotation direction converting unit 230, and allow the rotation force to be transferred to the drive sprocket wheel 4 through the ratchet 21b during the reverse rotation of pedal shaft, so as to thereby drive the drive sprocket wheel 4 in the forward direction.

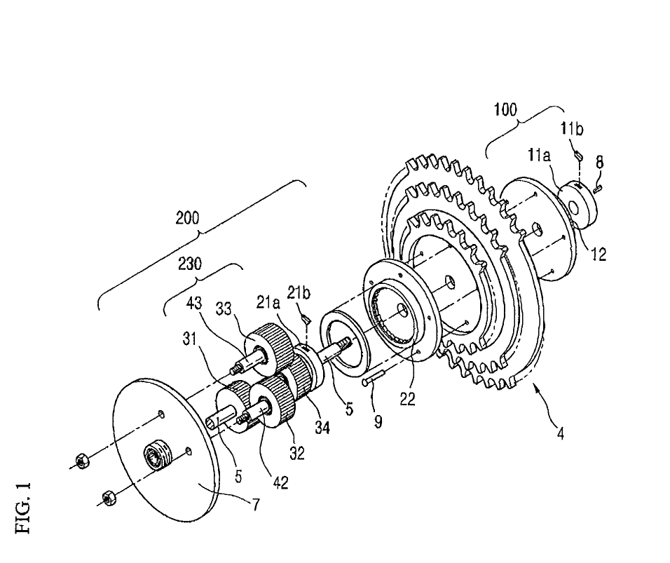

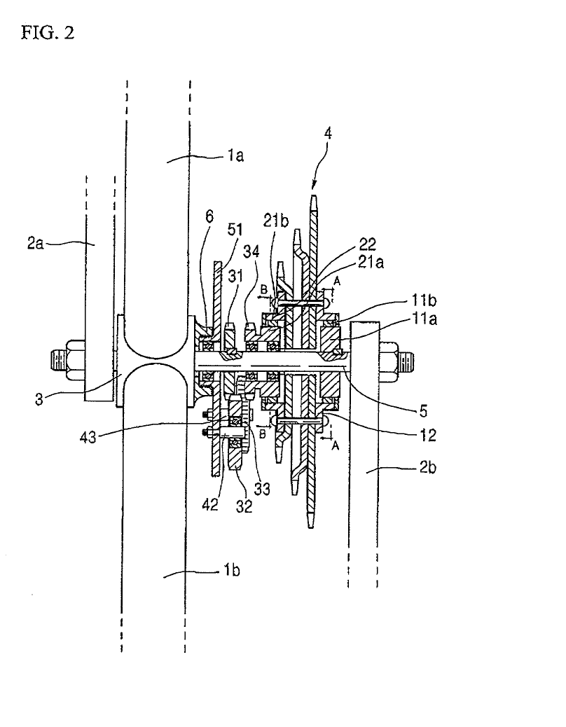

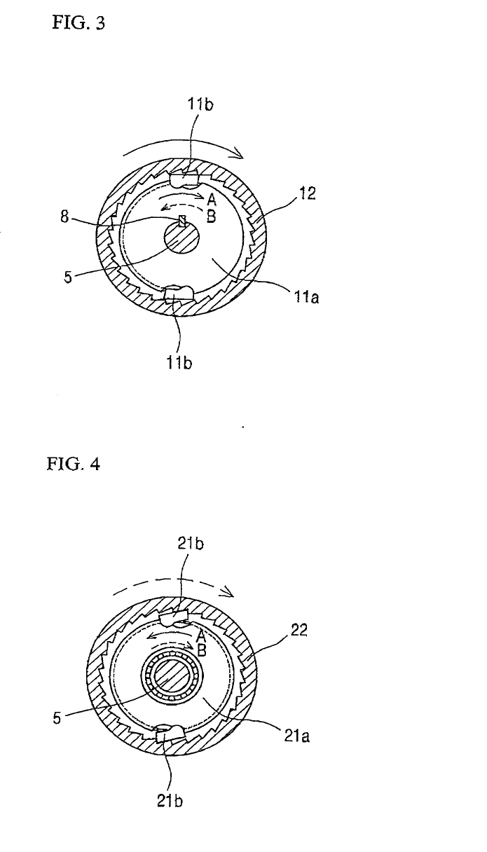

FIGS. 1 and 2 illustrate a first embodiment of a forward drive apparatus for a bicycle according to the present invention, and FIG. 3 and 4 are cross section views illustrating the operation state of the forward drive unit 100 and the reverse drive unit 200 according to the rotation direction of the pedal shaft 5, respectively.

The forward drive unit 100 is configured in that the drive disk 11a fixed to the pedal shaft 5 through a key 8 has at an outer periphery thereof a ratchet 11b, and only the forward rotating force of the pedal shaft is transferred to the drive sprocket wheel 4 by the ratchet wheel 12 fixed to a side surface of the drive sprocket wheel. In case where the pedal shaft 5 rotates in a reverse direction, the reverse rotating force of the drive disk 11a is prevented from being transferred to the ratchet wheel 12.

The reverse drive unit 200 is arranged at the other side surface of the drive sprocket wheel 4. The ratchet 21b and teeth of the ratchet wheel 22 are formed in the direction same as the direction of the ratchet 11b and teeth of the ratchet wheel 12 of the forward drive unit 100. The drive disk 21a supporting the ratchet 21b has a center portion thereof supported to the pedal shaft 5 through a bearing in such a manner that the drive disk 21a is not limited by the rotation of the pedal shaft 5. The drive disk 21a is formed integrally with the drive gear 34 of the rotation direction converting unit 230.

The rotation direction converting unit 230 of the reverse drive unit 200 serves to convert the reverse rotation of the pedal shaft 5 into a forward rotation, such that the drive disk 21a of the reverse drive unit 200 rotates in a forward direction. The rotation direction converting unit 230 includes a fixing gear 31 connected to the pedal shaft 5; a first connection gear 32 engaged with the fixing gear 31, and which rotates centering from a first rotating shaft 42; a second connection gear 33 engaged with the first connection gear 32, and which rotates centering from a second rotating shaft 43; and the drive gear 34 having a center thereof supported to the pedal shaft 5 through a bearing in such a manner that the drive gear is not limited by the rotating direction of the pedal shaft 5, and which rotates as being engaged with the second connection gear 33. The rotating shaft 42 of the first connection gear 32 and the rotating shaft 43 of the second connection gear 33 are fixed to a bracket 7 of a cap 6 of a shaft case or a frame 1a and 1b of a bicycle. Preferably, those gears have the same diameter, so as to thereby maintain the rotation speed and torque constant. The pedal shaft 5, the first rotating shaft 42 and the second rotating shaft 43 have rotation centers which form an equilateral triangle when interconnected.

The forward drive unit 100 and the reverse drive unit 200 employ the ratchet and ratchet wheel, such that the rotating force is transferred only when drive disks 11a and 21a rotate in one direction and the rotating force is not transferred when drive disks 11a and 21a rotate in the opposite direction. However, the forward drive unit 100 and the reverse drive unit 200 adapt a wide variety of one direction clutches which allow the rotating force to be transferred only in one direction and prevent the rotating force from being transferred in the opposite direction.

Thus-configured forward drive apparatus according to the first embodiment of the present invention operates as follows.

When the pedal shaft 5 rotates in a forward direction, the drive disk 11a of the forward drive unit 100 rotates in a forward direction, and the ratchet 11b applies a rotating force to the ratchet wheel 12, thus driving the drive sprocket wheel 4 in a forward direction. Here, the ratchet 21b of the reverse drive unit 200 rotates as being slipped in the direction opposite to the rotating direction of the ratchet wheel 22.

In detail, the fixing gear 31 of the rotation direction converting unit 230 rotates in the forward direction which is the same as the rotating direction of the pedal shaft 5. The first connection gear 32 engaged with the fixing gear 31 rotates in a reverse direction centering from the first rotation shaft 42 and the second connection gear 33 engaged with a first connection gear 32 rotates in a forward direction centering from a second rotation shaft 43. The drive gear 34 engaged with the second connection gear 33 rotates in a reverse direction centering from the pedal shaft 5. That is, the first connection gear 32 and the second connection gear 33 serve to convert the rotating direction of the drive gear 34 into the direction opposite to the rotating direction of the fixing gear 31.

Accordingly, the drive disk 21a of the reverse drive unit 200, which is formed integrally with the drive gear 34 rotates in the reverse direction, and the ratchet 21b of the reverse drive unit 200 slips against the ratchet wheel 22 fixed to the drive sprocket wheel 4 rotating in a forward direction. Therefore, the drive sprocket wheel 4 rotates in a forward direction by the forward drive unit 100, and the power is transferred to the slave sprocket wheel through a chain.

FIG. 3 is a cross section view taken along the line A-A of FIG. 2, illustrating the operating state of the forward drive unit 100 in accordance with the rotating direction of the pedal shaft 5. FIG. 4 is a cross section view taken along the line B-B of FIG. 2, illustrating the operating state of the reverse drive unit 200 in accordance with the rotating direction of the pedal shaft 5. The forward drive unit 100 and the reverse drive unit 200 have ratchets 11b and 21b and ratchet wheels 12 and 22 which are functioning as one-direction clutch means and installed in the same direction. The drive disk 11a of the forward drive unit 100 rotates along the direction of “A” marked as a solid line in FIG. 3, by the forward rotation of the pedal shaft 5, and the ratchet 11b rotates as being engaged with the ratchet wheel 12, to thereby allow the drive sprocket wheel 4 to rotate in a forward direction. Here, the drive disk 21a of the reverse drive unit 200 rotates in a reverse direction marked as “A” in FIG. 4, opposite to the rotation direction of the pedal shaft. Therefore, the ratchet wheel 22 rotating in a forward direction together with the drive sprocket wheel 4 is slipped to the ratchet 21b and rotates in a forward direction.

On the contrary, when the pedal shaft 5 rotates in a reverse direction, the drive disk 11a of the forward drive unit 100 rotates in a reverse direction. As a consequence, the ratchet 11b is slipped and rotates in the direction opposite to the rotating direction of the ratchet wheel 12, and the drive disk 21a of the reverse drive unit 200 rotates in a forward direction. Thus, the ratchet 21b allows the ratchet wheel 22 to be driven in a forward direction, and the drive sprocket wheel 4 continuously rotates in a forward direction.

To put this in detail, the fixing gear 31 of the rotation direction converting unit 230 connected to the pedal shaft 5 rotates in a reverse direction which is same as the rotating direction of the pedal shaft 5. The first connection gear 32 engaged with the fixing gear 31 rotates in a forward direction centering from the first rotation shaft 42, and the second connection gear 33 engaged with the first connection gear 32 rotates in a reverse direction centering from the second rotation shaft 43. The drive gear 34 engaged with the second connection gear 33 rotates in a forward direction, opposite to the rotating direction of the pedal shaft 5, centering from the pedal shaft 5. This results in the forward rotation of the drive disk 21a of the reverse drive unit 200 arranged integrally with the driving gear 34. Thus, the ratchet 21b of the reverse drive unit 200 applies a forward rotating force to the ratchet wheel 22, to thereby allow the drive sprocket wheel 4 to maintain rotation in a forward direction.

Referring to FIGS. 3 and 4, the drive disk 11a of the forward drive unit 100 rotates in the direction of “B” marked as a dot line in FIG. 3, by the reverse rotation of the pedal shaft 5, and the ratchet 11b is slipped, in failure of transferring the driving force to the ratchet wheel 12. The drive disk 21a of the reverse drive unit 200 rotates in the direction of “B” marked in FIG. 4, opposite to the rotating direction of the pedal shaft 5, and the ratchet wheel 22 rotates in a forward direction, to thereby allow the drive sprocket wheel 4 to maintain rotation in a forward direction.

The forward drive apparatus for bicycle according to the present invention, permits the bicycle to work in a forward movement through the simple reverse rotation of pedal, eliminating the need of operating an additional clutch or lever. Due to it that the forward drive apparatus of the present invention maintains the rotating direction of the drive sprocket wheel 4 regardless of the rotating direction of the pedal shaft 5, it is possible to prevent an impact load from being applied to the drive apparatus which may otherwise be caused by the change of rotating direction of the pedal shaft 5. Thus, power transmission components are protected from an excess load.

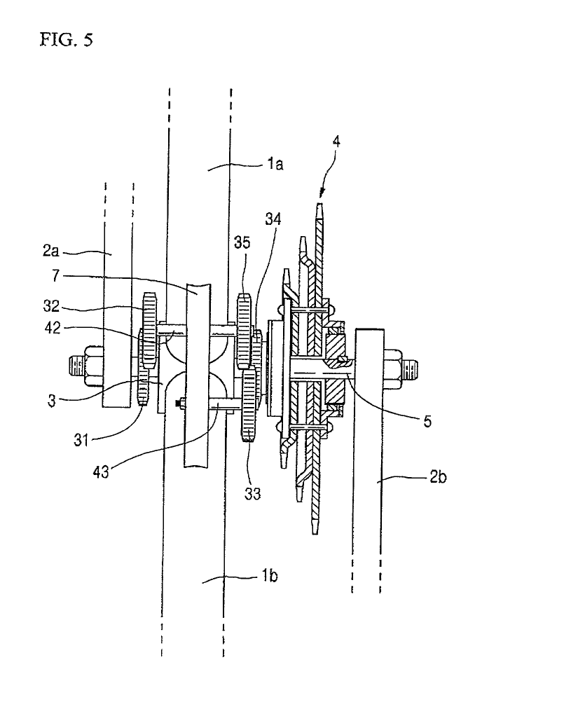

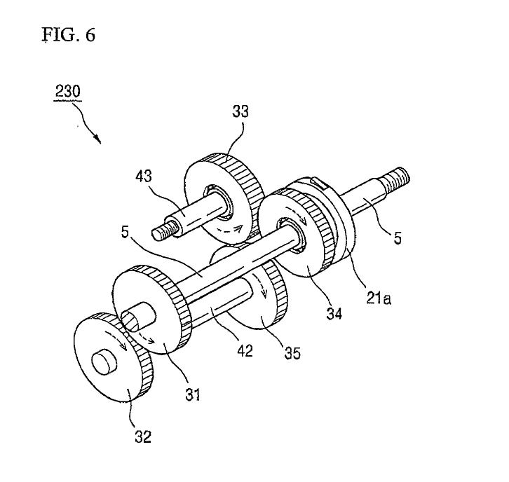

FIGS. 5 and 6 illustrate the second embodiment of the present invention, in which gears of the rotation direction converting unit 230 of the reverse drive unit 200 of the first embodiment are partially moved to the pedal shaft arranged at the opposite side of the shaft case 3 of the main frame 1a and 1b, to thereby allow the pedal shaft 5 to be balanced centering from the shaft case.

That is, in the second embodiment of the present invention, the fixing gear 31 and the first connection gear 32 engaged with the fixing gear 31, from among the components of the rotation direction converting unit 230 of the reverse drive unit 200 are arranged at the opposite side from the forward drive unit 100 centering from the main frame 1a and 1b. Here, the rotation shaft 42 of the first connection gear 32 is extended and has at the extended end thereof the relay gear 35 engaged with the second connection gear 33, so that the rotating force of the first connection gear 32 is transferred to the second connection gear 33. The rotation shaft 42 penetrates through the bracket 7 of the main frame 1a and 1b so as to be supported by the bearing arranged in the bracket 7.

The forward drive apparatus of the second embodiment of the present invention operates as follows. Since the first connection gear 32 and the relay gear 35 rotate in the same direction by the first rotation shaft 42, the relay gear 35 rotates the second connection gear 33. Thus, the first connection gear 32 and the relay gear 35 of the second embodiment operate in a manner similar to the first connection gear 32 of the first embodiment.

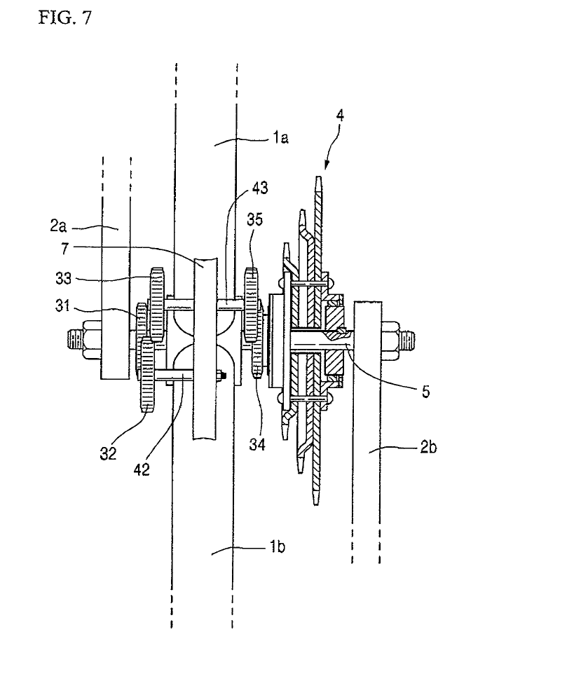

The third embodiment of the present invention shown in FIGS. 7 and 8 is a modification of the second embodiment of the present invention. In the third embodiment, the fixing gear 31, the first connection gear 32 and the second connection gear 33, from among the components of the rotation direction converting unit 230 of the reverse drive unit 200 are arranged at the opposite side from the forward drive unit 100 centering from the main frame la and lb. Here, the rotation shaft 43 of the second connection gear 33 is extended and has at the extended end thereof the relay gear 35 engaged with the drive gear 34, so that the rotating force of the second connection gear 33 is transferred to the drive gear 34.

The forward drive apparatus of the third embodiment of the present invention operates as follows. Since the second connection gear 33 and the relay gear 35 rotate in the same direction by the second rotation shaft 43, the relay gear 35 rotates the drive gear 34. Thus, the second connection gear 33 and the relay gear 35 of the third embodiment operate in a manner similar to the second connection gear 33 of the first embodiment.

In the third embodiment, the first connection gear 32 serves to transfer the rotating force of the fixing gear 31 to the second connection gear 33 and convert the rotating direction of the second connection gear 33 in such a manner that the second connection gear rotates in the direction same as the rotating direction of the fixing gear 31. In a fourth embodiment of the present invention, the first connection gear 32 is removed from the configuration, and the fixing gear 31 and the second connection gear 33 are directly connected through a timing belt and rotate in the same direction.

FIG. 8 illustrates the fourth embodiment of the present invention, in which the fixing gear 31 is replaced by a fixing sprocket 51, the second connection gear 33 is replaced by a connection sprocket 53, and sprockets 51 and 53 are interconnected through a chain 50 for transferring a rotating force.

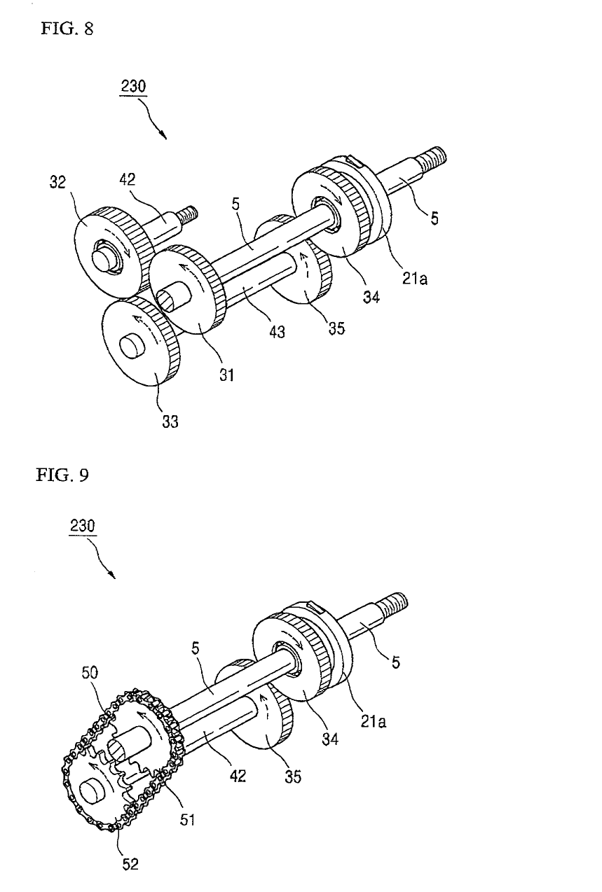

FIG. 9 illustrates a fifth embodiment which is obtained by modifying the second embodiment. In the fifth embodiment, the second connection gear 33 is removed from the configuration, and the relay gear 35 and the drive gear 34 are directly connected through a timing belt and rotate in the same direction.

As described above, the forward drive apparatus of the present invention is advantageous in that the bicycle is driven forward through the simple reverse rotation of the pedal, without operating an additional clutch or lever, and the operation of bicycle is not interrupted at all even when the pedal has stopped during travel.

The forward drive apparatus of the present invention is mounted to the pedal shaft, the bicycle is easily drawn forward in case where the user draws the bicycle rather than riding on it. Since the rotation direction converting unit 230 of the present invention has gears with same diameters, rotating speed of the pedal is not changed during the reverse and forward pedaling, to thereby achieve an improved convenience and exercising effects for the bicycle rider.

Further, the forward drive apparatus of the present invention maintains the rotating direction of the drive sprocket wheel 4 regardless of the rotating direction of the pedal shaft. As a consequence the impact load is prevented from being applied to the drive apparatus which may otherwise be caused by the change of rotating direction of the pedal shaft.

The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. In a forward drive apparatus for a bicycle for working the bicycle in a forward movement by a reverse rotation of a pedal shaft, said forward drive apparatus comprising a forward drive unit in which a ratchet is arranged at an outer periphery of a drive disk fixed to said pedal shaft through a key such that only a forward rotating force of said pedal shaft is transferred to a drive sprocket wheel by a ratchet wheel fixed to a side surface of said drive sprocket wheel; and a reverse drive unit including a rotation direction converting unit for rotating a drive gear having a center thereof supported to said pedal shaft through a bearing and which is formed integrally with a drive disk, in a direction opposite to the rotating direction of said pedal shaft by a rotating force of a fixing gear connected to said pedal shaft, said drive disk having at an outer periphery thereof a ratchet and being formed integrally with said drive gear of said rotation direction converting unit, and a ratchet wheel fixed to the other side surface of said drive sprocket wheel and interlocked with said ratchet,
whereby working the bicycle in a forward movement regardless of a rotating direction of said pedal shaft.

2. A forward drive apparatus according to claim 1, wherein said rotation direction converting unit further comprises
a fixing gear connected to said pedal shaft;
a first connection gear engaged with said fixing gear, and which rotates centering from a first rotating shaft;
a second connection gear engaged with said first connection gear, and which rotates centering from a second rotating shaft; and
said drive gear engaged with said second connection gear and rotates,
wherein said rotating direction converting unit converts a reverse rotation of said pedal shaft into a forward rotation, to thereby allow said drive disk of said rotation direction converting unit to rotate in a forward direction.

3. A forward drive apparatus according to claim 2, wherein said fixing gear and said first connection gear are arranged opposite to said drive sprocket wheel, based on said main frame,
said first rotation shaft of said first connection gear has at an extended end thereof a relay gear engaged with said second connection gear so as to transfer a rotating force of said first connection gear to said second connection gear, and said first rotation shaft of said first connection gear is fixed to a bracket of said main frame through a bearing.

4. A forward drive apparatus according to claim 2, wherein said fixing gear, said first connection gear and said second connection gear are arranged opposite to said drive sprocket wheel, based on said main frame,
said second rotation shaft of said second connection gear has at an extended end thereof a relay gear engaged with said drive gear so as to transfer a rotating force of said second connection gear to said drive gear, and said second rotation shaft of said second connection gear is fixed to a bracket of said main frame through a bearing.

5. A forward drive apparatus according to claim 1, wherein said rotation direction converting unit further comprises
a fixing gear arranged opposite to said drive sprocket wheel based on a main frame and connected to said pedal shaft;
a first connection gear engaged with said fixing gear and which rotates centering from a rotation shaft;
a relay gear arranged opposite to said drive sprocket wheel based on said main frame, and connected to an extended end of said rotation shaft of said first connection gear;
a drive gear rotating in a direction same as a rotating direction of said relay gear through a belt transmission means; and
a bracket fixed to said main frame, and which supports said rotation shaft of said first connection gear through a bearing,
wherein said rotation direction converting unit converts a reverse rotation of said pedal shaft into a forward rotation, to thereby allow said drive disk of said reverse drive unit to rotate in a forward direction.

6. A forward drive apparatus according to claim 1, wherein said rotation direction converting unit further comprises
a fixing gear arranged opposite to said drive sprocket wheel based on a main frame and connected to said pedal shaft;
a first connection gear which rotates in a direction same as the rotating direction of said fixing gear through a belt transmission means, centering from a rotation shaft;
a relay gear arranged opposite to said drive sprocket wheel based on said main frame, and connected to an extended end of said rotation shaft of said first connection gear;
a drive gear engaged with said relay gear and which rotates centering from said pedal shaft; and
a bracket fixed to said main frame, and which supports said rotation shaft of said first connection gear through a bearing,
wherein said rotation direction converting unit converts a reverse rotation of said pedal shaft into a forward rotation, to thereby allow said drive disk of said reverse drive unit to rotate in a forward direction.
